(19) United States
(12) Patent Application Publication
(10) Pub. No.: US 2026/0313760 A1
(43) Pub. Date: Oct. 8, 2026

(54) INDUCTION HEATING MEMBER, INDUCTION HEATING DEVICE, AND COOKTOP

(71) Applicant: LG ELECTRONICS INC., Seoul (KR)

(72) Inventors: Dooyong OH, Seoul (KR); Hyunwoo JUN, Seoul (KR); Jaepyo HONG, Seoul (KR); Seongho SON, Seoul (KR); Yongsoo LEE, Seoul (KR)

(21) Appl. No.: 19/482,349

(22) PCT Filed: May 9, 2024
(86) PCT No.: PCT/KR2024/006247

§ 371 Date: Nov. 7, 2025

(30) Foreign Application Priority Data
May 9, 2023 (KR) 10-2023-0060093

(51) Int. Cl. H05B 6/12; H05B 6/44

(52) U.S. Cl. CPC H05B 6/1209; H05B 6/44

(57) ABSTRACT

The purpose of the present disclosure is to provide a cooktop having an undetermined heating zone, in which an object to be heated is heated, having reduced heating unit manufacturing time and manufacturing costs, and having high efficiency. Presented is an induction heating member comprising a substrate and a heating unit printed on the substrate, wherein the heating unit includes at least one coil in which a plurality of unit coils are printed in a hexagonal shape.

### TECHNICAL FIELD

The present disclosure relates to an induction heating member, an induction heating device, and a cooktop.

### BACKGROUND ART

Various cooking appliances are used to heat food at home and in restaurants. While gas ranges have traditionally been widely used, devices that heat objects, such as cooking vessels like pots, using electricity instead of gas are becoming more widespread.

Methods for heating objects using electricity are broadly categorized into resistance heating and induction heating. Resistance heating involves passing current through a metal resistance wire or a non-metallic heating element, such as silicon carbide, to heat the object (e.g., a cooking vessel) by transferring the heat generated by the current to the object through radiation or conduction. Induction heating, on the other hand, involves applying a predetermined amount of high-frequency power to a coil. This generates a magnetic field around the coil, generating eddy currents in the metal object, thereby heating the object itself.

Recently, induction heating is widely used in cooktops.

These induction heating cooktops include a working coil that generates a magnetic field. Conventionally, the working coil is formed by a plurality of turns of a coil with a predetermined cross-sectional area. Cooktops also include a working coil base that supports and secures the working coil and guides its winding position.

However, these cooktops have the disadvantage of being bulky due to the space occupied by the working coil and the working coil base. In addition, there is a problem of increased manufacturing time and manufacturing cost due to the manufacturing inconvenience of winding the working coil around the working coil base.

### DISCLOSURE OF THE INVENTION

### Technical Problem

One object of the present disclosure is to provide an induction heating member, an induction heating device, and a cooking appliance that can shorten the manufacturing time of an induction heating element and reduce manufacturing costs.

Another object of the present disclosure is to provide a cooking appliance including a PCB pattern coil.

Another object of the present disclosure is to provide a cooking appliance in which a heating zone where an object to be heated is heated is not defined.

### Technical Solution

An induction heating member according to an embodiment of the present disclosure can be manufactured in a form in which a coil is printed on a Printed Circuit Board (PCB).

An induction heating member according to an embodiment of the present disclosure can have a coil printed on the PCB in a polygonal, particularly hexagonal, shape.

An induction heating member according to an embodiment of the present disclosure may include a substrate; and a heating element printed on the substrate, wherein the heating element includes at least one coil printed in a hexagonal shape.

The coil has at least one turn, and the turn may be formed into a plurality of unit coils.

The plurality of unit coils may be alternately arranged on an upper surface and a lower surface of the substrate.

Each of the plurality of unit coils may be divided into a segment printed on the upper surface of the substrate and a segment printed on the lower surface of the substrate.

The segment printed on the upper surface of the substrate and the segment printed on the lower surface of the substrate may be connected through a via.

The via may be formed at one end of the segment, and the segment may be a segment that forms at least a portion of an outermost turn.

The via may be formed at one end of the segment, and the segment may be a segment that forms at least a portion of an innermost turn.

A via may be formed at both ends of a segment, and the segment may form a portion of an outermost turn and a remaining portion of an innermost turn.

A first coil among the plurality of coils may have a plurality of adjacent coils, and the first coil may be printed such that a distance to each of the plurality of adjacent coils is the same.

An induction heating device according to an embodiment of the present disclosure may be formed in a structure in which a plurality of induction heating members are vertically stacked.

A cooktop according to an embodiment of the present disclosure may include at least one induction heating member.

### Effects of the Invention

According to an embodiment of the present disclosure, since the coil is printed on a PCB, the manufacturing process is simplified and easy, thereby reducing manufacturing time and reducing manufacturing costs. Furthermore, the simplified and easy manufacturing process, as described above, allows for mass production.

According to an embodiment of the present disclosure, when printed in a hexagonal shape, the coils are densely printed on the PCB, minimizing output variation depending on location, thereby allowing the object to be heated to be heated at any location.

According to an embodiment of the present disclosure, when the coil is printed in a hexagonal shape, the current output is lower compared to a coil printed in a circular shape, thereby reducing heat generation and increasing maximum output.

### BRIEF DESCRIPTION OF DRAWINGS

FIG. 1 is a perspective view illustrating a cooktop and a cooking vessel according to an embodiment of the present disclosure.

FIG. 2(a) to (b) are cross-sectional views of a cooktop and a cooking vessel according to an embodiment of the present disclosure.

FIG. 3 is a circuit diagram of a cooktop according to an embodiment of the present disclosure.

FIG. 4 is a diagram illustrating the output characteristics of a cooktop according to an embodiment of the present disclosure.

FIG. 5 is a diagram illustrating an induction heating member according to an embodiment of the present disclosure.

FIG. 6(a) to (b) are enlarged views of region A and its rear surface in FIG. 5.

FIG. 7(a) to (b) are enlarged views of area B in FIG. 6.

FIG. 8(a) to (b) are diagrams illustrating an induction heating device according to an embodiment of the present disclosure.

FIG. 9 is a diagram illustrating the characteristics of a plurality of coils printed in circular and hexagonal shapes, respectively.

### BEST MODE

Hereinafter, embodiments related to the present disclosure will be described in more detail with reference to the drawings. The suffixes “module” and “element” used in the following description for components are assigned or used interchangeably solely for the convenience of writing the specification, and do not in themselves have distinct meanings or roles.

Hereinafter, an induction heating cooking appliance and an operating method thereof according to an embodiment of the present disclosure will be described. The cooking appliance may include a cooktop. For convenience of explanation, the cooking appliance will be described below using an “induction heating cooktop” or “cooktop” as an example.

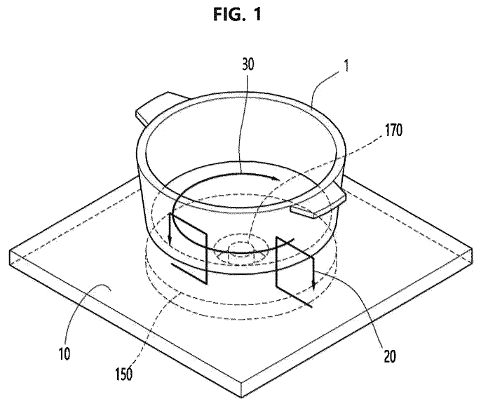

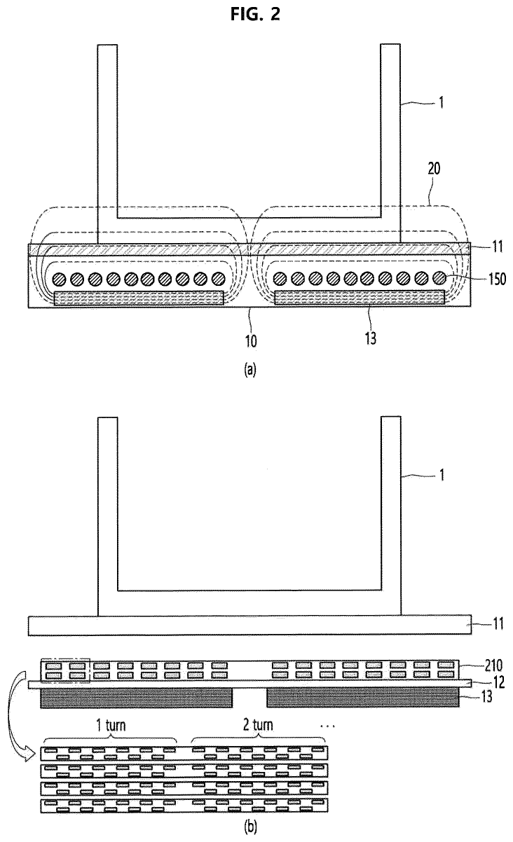

FIG. 1 is a perspective view illustrating a cooktop and a cooking vessel according to an embodiment of the present disclosure, and FIG. 2 is a cross-sectional view of a cooktop and a cooking vessel according to an embodiment of the present disclosure.

The cooking vessel 1 can be positioned above a cooktop 10, and the cooktop 10 can heat the cooking vessel 1 positioned thereon.

First, a method by which the cooktop 10 heats the cooking vessel 1 will be described.

As illustrated in FIG. 1, the cooktop 10 can generate a magnetic field 20 such that at least a portion of the magnetic field passes through the cooking vessel 1. If the material of the cooking vessel 1 contains an electrical resistive component, the magnetic field 20 can induce an eddy current 30 in the cooking vessel 1. This eddy current 30 generates heat within the cooking vessel 1, and this heat is conducted or radiated to the interior of the cooking vessel 1, thereby cooking the contents of the cooking vessel 1.

Meanwhile, if the material of the cooking vessel 1 does not contain electrical resistance, eddy currents 30 do not occur. Therefore, in this case, the cooktop 10 cannot heat the cooking vessel 1.

Therefore, the cooking vessel 1 that can be heated by the cooktop 10 may be a metal vessel, such as stainless steel, enamel, or cast iron.

Next, the method by which the cooktop 10 generates a magnetic field 20 will be described.

(a) of FIG. 2 illustrates a cross-sectional view of the cooktop 10 including a working coil, and (b) of FIG. 2 illustrates a cross-sectional view of the cooktop 10 including a PCB pattern coil.

Although not shown, the cooktop 10 may also heat the cooking vessel 1 by including a portion of the working coil and a portion of the PCB pattern coil. At this time, the working coil and the PCB pattern coil may be arranged in units of burners formed on the cooktop 10.

First, referring to (a) of FIG. 2, the cooktop 10 may include at least one of a top plate 11, a working coil 150, and a ferrite core 13.

The top plate 11 may be configured to support a cooking vessel 1 and place the cooking vessel 1. That is, the cooking vessel 1 may be placed on a upper surface of the top plate 11. At least one heating zone (or burner as described above) for heating the cooking vessel 1 may be formed on the top plate 11.

The top plate 11 may be formed of tempered glass made of a ceramic material synthesized from various minerals. Accordingly, the top plate 11 may protect the cooktop 10 from external impacts, etc.

Additionally, the top plate 11 can prevent foreign substances such as dust from entering the cooktop 10.

The working coil 150 may be located beneath the top plate 11. This working coil 150 may or may not be supplied with current to generate a magnetic field 20. Specifically, current may or may not flow through the working coil 150 depending on the on/off state of the switching element within the cooktop 10.

When current flows through the working coil 150, a magnetic field 20 is generated, and this magnetic field 20 may encounter the electrical resistance component contained in the cooking vessel 1 to generate an eddy current 30. The eddy current 30 heats the cooking vessel 1, thereby cooking the contents of the cooking vessel 1.

In addition, the heat output of the cooktop 10 can be controlled depending on the amount of current flowing through the working coil 150. For example, the greater the current flowing through the working coil 150, the more the magnetic field 20 is generated, which in turn increases the magnetic field passing through the cooking vessel 1, thereby increasing the heat output of the cooktop 10.

The ferrite core 13 is a component that protects the internal circuit of the cooktop 10. Specifically, the ferrite core 13 acts as a shield to block the magnetic field 20 generated by the working coil 150 from radiating to the outside, or acts as a shield to block the influence of an externally generated electromagnetic field on the internal circuit of the cooktop 10.

To this end, the ferrite core 13 may be formed of a material with very high permeability. The ferrite core 13 serves to guide the magnetic field flowing into the interior of the cooktop 10 so that it does not radiate but flows through the ferrite core 13. The movement of the magnetic field 20 generated in the working coil 150 by the ferrite core 13 may be as illustrated in (a) of FIG. 2.

Meanwhile, the cooktop 10 may further include other components in addition to the top plate 11, the working coil 150, and the ferrite core 13 described above. For example, the cooktop 10 may further include an insulating material (12 in (b) of FIG. 2) positioned between the top plate 11 and the working coil 150. That is, the cooktop according to the present disclosure is not limited to the cooktop 10 illustrated in (a) of FIG. 2.

Next, referring to (b) of FIG. 2, the cooktop 10 may be configured to include at least one of a top plate 11, a PCB pattern coil 210, an insulator 12, and a ferrite core 13.

When describing the components of the cooktop 10 illustrated in (b) of FIG. 2, the same components as in (a) of FIG. 2 are used for their functions and roles, and thus, a redundant description thereof will be omitted.

As illustrated, the cooktop 10 of (b) of FIG. 2 uses a PCB pattern coil 210 instead of a working coil 150 to heat the cooking vessel 1, unlike the cooktop 10 of (a) of FIG. 2.

Referring to (b) of FIG. 2, the PCB pattern coil 210 may be disposed on a lower surface of the top plate 11.

Referring to (b) of FIG. 2, the PCB pattern coil 210 may be disposed on the upper surface of the ferrite core 13.

Referring to (b) of FIG. 2, the PCB pattern coil 210 may be disposed on the upper surface of the insulator 12.

Referring to (b) of FIG. 2, the PCB pattern coil 210 may be disposed between the top plate 11 and the ferrite core 13.

Referring to (b) of FIG. 2, the PCB pattern coil 210 may be disposed between the top plate and the insulator 12.

The PCB pattern coil 210 may be formed in a single-layer or multi-layer structure.

For example, in (b) of FIG. 2, unlike the working coil 150 illustrated in (a) of FIG. 2, the PCB pattern coil 210 is illustrated as a multi-layer structure formed in two layers.

The PCB pattern coil 210 may be formed with a plurality of turns.

If the PCB pattern coil 210 is a single layer, it may be formed with the plurality of turns.

If the PCB pattern coil 210 is a multi-layer structure, each layer may have the plurality of turns, as illustrated in (b) of FIG. 2.

In a PCB pattern coil 210 formed with a single turn or the plurality of turns, each turn may include a plurality of strands 220.

Referring to (b) of FIG. 2, each strand in each turn may not overlap with another strand. Here, “overlap” may refer to, for example, a case where one strand does not overlap another strand in the vertical direction toward the top plate 11. This may be to minimize damage caused by malfunctions, as well as to improve heating and insulation efficiency.

Referring to (b) of FIG. 2, the strands arranged in each turn in each layer overlap each other in position, which is an example of an attempt to increase heating efficiency.

However, the present disclosure is not limited to the details illustrated in (b) of FIG. 2 or described above.

Meanwhile, although not illustrated, the layer structure of the PCB pattern in (b) of FIG. 2 may vary depending on the heating zone. For example, if a cooktop has a plurality of heating zones, the PCB pattern coil responsible for the first heating zone may be formed as a single-layer structure, while the PCB pattern coil responsible for the second heating zone may be formed as a multi-layer structure.

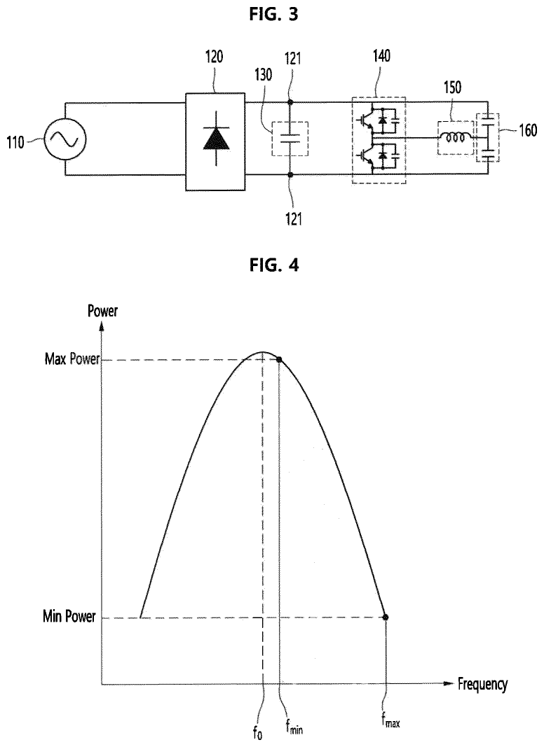

FIG. 3 is a circuit diagram of a cooktop according to an embodiment of the present disclosure.

The circuit diagram of the cooktop 10 illustrated in FIG. 3 is merely illustrative for convenience of explanation, and the present disclosure is not limited thereto.

Referring to FIG. 3, the induction heating cooktop may include at least some or all of a power supply unit 110, a rectifier unit 120, a DC link capacitor 130, an inverter 140, a working coil 150, and a resonant capacitor 160.

The power supply unit 110 may receive external power. The external power input to the power supply unit 110 may be alternating current (AC) power.

The power supply unit 110 may supply AC voltage to the rectifier unit 120.

A rectifier 120 is an electrical device for converting alternating current (AC) to direct current (DC). The rectifier 120 converts the AC voltage supplied through the power supply 110 into DC voltage. The rectifier 120 can supply the converted voltage to both DC terminals 121.

The output terminal of the rectifier 120 can be connected to both DC terminals 121. The DC terminals 121 output through the rectifier 120 can be referred to as the “DC link.” The voltage measured at both DC terminals 121 can be referred to as the “DC link voltage.”

The DC link capacitor 130 acts as a buffer between the power supply 110 and the inverter 140. Specifically, the DC link capacitor 130 is used to maintain the DC link voltage converted through the rectifier 120 and supply it to the inverter 140.

The inverter 140 switches the voltage applied to the working coil 150 so that a high-frequency current flows through the working coil 150. The inverter 140 may include a semiconductor switch, and the semiconductor switch may be an Insulated Gate Bipolar Transistor (IGBT) or a Wide Band GaN (WBG) element. However, this is merely exemplary and should not be construed as being limited thereto. Meanwhile, the WBG element may be Silicon Carbide (SiC) or Gallium Nitride (GaN). The inverter 140 drives the semiconductor switch to cause a high-frequency current to flow through the working coil 150, thereby forming a high-frequency magnetic field in the working coil 150.

The working coil 150 may or may not have current flowing through it, depending on whether the switching element is driven. When current flows through the working coil 150, a magnetic field is generated. The working coil 150 generates a magnetic field according to the current flow, which can heat the cooking appliance.

One end of the working coil 150 is connected to the connection point of the switching element of the inverter 140, and the other end is connected to the resonant capacitor 160.

The switching element is driven by a driving unit (not shown). The switching time output from the driving unit is controlled, and the switching elements alternately operate, applying a high-frequency voltage to the working coil 150. Furthermore, since the on/off times of the switching elements applied from the driving unit (not shown) are gradually compensated, the voltage supplied to the working coil 150 changes from a low voltage to a high voltage.

The resonant capacitor 160 may be a component that functions as a buffer. The resonant capacitor 160 controls the saturation voltage rise rate during the turn-off of the switching element, thereby affecting energy loss during the turn-off time.

In the case of a cooktop 10 configured with a circuit diagram as illustrated in FIG. 3, the resonant frequency is determined by the inductance value of the working coil 150 and the capacitance value of the resonant capacitor 160. A resonance curve is formed around the determined resonant frequency, and the resonance curve can represent the output power of the cooktop 10 depending on the frequency band.

Next, FIG. 4 is a diagram illustrating the output characteristics of a cooktop according to an embodiment of the present disclosure.

First, the Q factor (quality factor) may be a value indicating the sharpness of resonance in a resonant circuit. In the case of a cooktop 10, the Q factor is determined by the inductance value of the working coil 150 included in the cooktop 10 and the capacitance value of the resonant capacitor 160. The resonance curve varies depending on the Q factor. Therefore, the cooktop 10 has different output characteristics depending on the inductance value of the working coil 150 and the capacitance value of the resonant capacitor 160.

FIG. 4 illustrates an example of a resonance curve according to the Q factor. Generally, the larger the Q factor, the sharper the curve. The smaller the Q factor, the blunter or gentler the curve.

The horizontal axis of the resonance curve may represent frequency, and the vertical axis may represent the output power. The frequency at which maximum power is output in the resonance curve is called the resonant frequency (f0).

Generally, the cooktop 10 uses the frequency range to the right of the resonant frequency (f0) of the resonance curve. Furthermore, the cooktop 10 may have preset minimum and maximum operating frequencies.

For example, the cooktop 10 may operate at a frequency within the range between the maximum operating frequency (fmax) and the minimum operating frequency (fmin). In other words, the operating frequency range of the cooktop 10 may range from the maximum operating frequency (fmax) to the minimum operating frequency (fmin).

For example, the maximum operating frequency (fmax) may be the IGBT maximum switching frequency. The IGBT maximum switching frequency may refer to the maximum frequency at which the IGBT switching element can operate, taking into account factors such as the withstand voltage and capacity. For example, the maximum operating frequency (fmax) may be 75 kHz.

The minimum operating frequency (fmin) may be approximately 20 kHz. In this case, since the cooktop 10 does not operate at an audible frequency (approximately 16 Hz to 20 kHz), noise from the cooktop 10 can be reduced.

Meanwhile, the above-described maximum operating frequency (fmax) and minimum operating frequency (fmin) settings are merely exemplary and are not limited thereto.

Upon receiving a heating command, the cooktop 10 may determine the operating frequency based on the heat level set in the heating command. Specifically, the cooktop 10 can adjust the output power by lowering the operating frequency as the set heat power level increases, and by raising the operating frequency as the set heat power level decreases. That is, when the cooktop 10 receives a heating command, it can perform a heating mode in which it operates in any of the operating frequency ranges according to the set heat power.

Meanwhile, as illustrated in FIG. 2, the working coil 150 may be formed in a form in which a coil having a cross-sectional area of a predetermined size is wound. However, in this case, a winding machine for winding the working coil 150 is required. The winding machine may be a working coil base (not shown). In this case, there is a disadvantage in that the overall volume of the cooktop 10 increases due to the volume occupied by the working coil 150 and the working coil base (not shown) supporting the working coil 150.

Furthermore, due to the difficulty of manufacturing the working coil 150 by winding it around the working coil base (not shown), both manufacturing time and manufacturing cost increase.

Therefore, the cooktop according to the present disclosure utilizes a coil printed on a Printed Circuit Board (PCB), i.e., a PCB pattern coil.

The present disclosure provides an induction heating member in which a coil generating a magnetic field for induction heating is printed on a PCB.

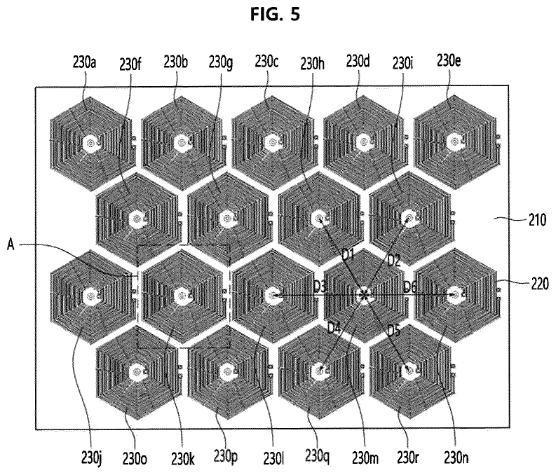

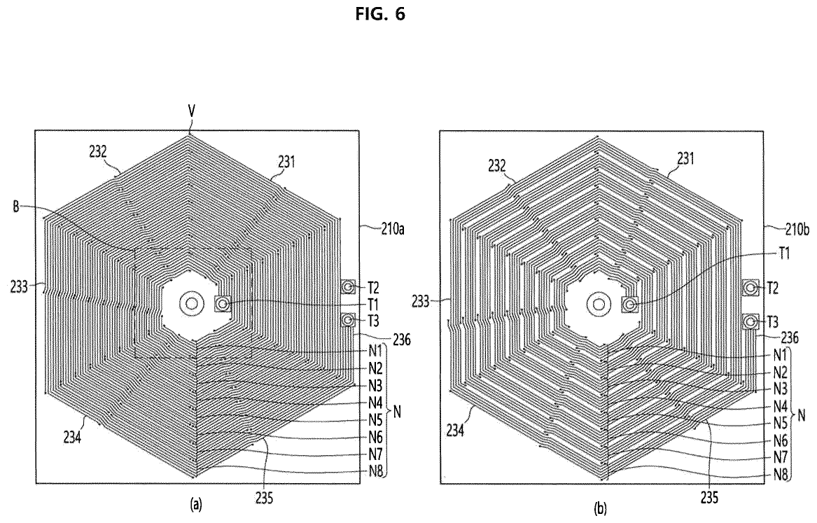

FIG. 5 is a drawing illustrating an induction heating member according to an embodiment of the present disclosure.

The induction heating member according to an embodiment of the present disclosure may include a substrate 210 and a heating member 220 printed on the substrate 210. In this case, the heating member 220 may include at least one coil. Alternatively, the heating member 220 may include a plurality of coils 230a to 230r.

The plurality of coils 230a to 230r can be manufactured in a printed form on a substrate 210. FIG. 5 illustrates 19 coils printed on a substrate 210. However, this is merely an example, and the number of coils can be varied and may be arbitrary.

Since coils were conventionally designed in a coil-wound form, it was difficult to manufacture coils in a straight shape. However, when printing coils on a substrate 210 as described herein, design limitations can be overcome. For example, the shapes of the coils 230a to 230r printed on the substrate 210 can vary.

Each of the plurality of coils 230a to 230r can be printed in a circular shape.

Each of the plurality of coils 230a to 230r can be printed in a polygonal shape. Here, the polygonal shape may include a square, a pentagon, a hexagon, etc.

Meanwhile, the heating unit 220 may include one or more coils 230a to 230n at least partially printed in a straight line. However, considering the number and efficiency of coil shapes that can be printed on the PCB, the coil shape will be described below as an example printed in a hexagonal shape. However, this is merely an example, and as mentioned above, the degree of freedom in coil shape design is high. From this perspective, the shape of each coil printed on a single PCB need not be identical.

As in the example of FIG. 5, when each of the plurality of coils 230a to 230r is printed in a hexagonal shape, the distance from the center of one coil to the center of another adjacent coil may be constant. For example, the distance from the center of one coil to the center of another adjacent coil may be approximately 90 mm, but this is merely an example and should not be considered limiting.

Among the plurality of coils 230a to 230r, the first coil 230m is adjacent to the plurality of coils 230h, 230i, 2301, 230n, 230q, 230r, 230h, 230i, 230l, 230n, 230q, and 230r, and the first coil 230m can be printed so that the distance to each of the plurality of adjacent coils 230h, 230i, 230l, 230n, 230q, 230r, 230h, 230i, 230l, 230n, 230q, and 230r is the same. That is, the distance D1 between the first coil 230m and the second coil 230h, the distance D2 between the first coil 230m and the third coil 230i, the distance D3 between the first coil 230m and the fourth coil 2301, the distance D4 between the first coil 230m and the fifth coil 230q, the distance D5 between the first coil 230m and the sixth coil 230r, and the distance D6 between the first coil 230m and the seventh coil 230n may all be the same.

That is, when a plurality of coils 230a to 230r are printed in a hexagonal shape, the plurality of coils 230a to 230r may have a honeycomb-shaped structure. Accordingly, the distance between the center of each coil and the center of the adjacent coil may be the same in any direction. That is, when the plurality of coils 230a to 230r are printed in a hexagonal shape, the coil density can be maximized. Accordingly, there is an advantage in that the area occupied by the coils on the substrate 210, i.e., the coil density on the substrate 210, is maximized.

Next, the structure of each of the plurality of coils 230a to 230r will be described in detail.

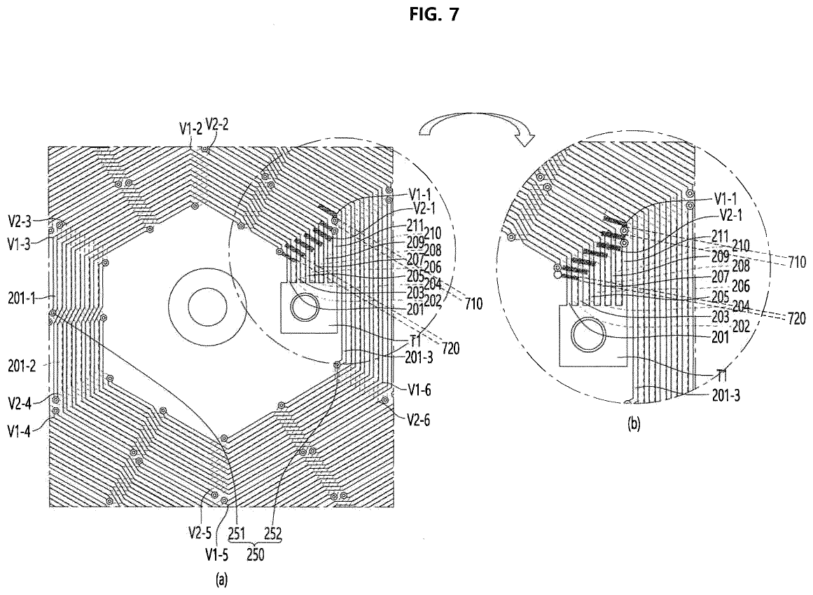

FIG. 6 is an enlarged view of region A of FIG. 5 and its rear surface, and FIG. 7 is an enlarged view of area B of FIG. 6.

Specifically, (a) of FIG. 6 is an enlarged view of region A of FIG. 5, and (b) of FIG. 6 is an enlarged view of the rear surface, which is the opposite surface of region A of FIG. 5. That is, (b) of FIG. 6 is the opposite surface of (a) of FIG. 6.

Each of the plurality of coils 230a to 230r may be formed with at least one terminal for connection to other coils. Referring to FIG. 6, each of the plurality of coils 230a to 230r may be formed with three terminals T1, T2, and T3. However, the number of terminals is merely exemplary and should not be limited thereto.

Of the three terminals T1, T2, and T3, one may be connected to a coil printed on the same substrate, another may be connected to a coil printed on a substrate arranged in an upper layer, and the remaining terminal may be connected to a coil printed on a substrate arranged in a lower layer.

Referring to the example of FIG. 6, each of the plurality of coils 230a to 230r may have a printed shape having a plurality of turns N from the first terminal T1 to the third terminal T3.

Additionally, it can be confirmed that at least a portion of each of the plurality of coils 230a to 230r is printed as a straight line. Specifically, each of the plurality of coils 230a to 230r is a hexagon with six sides 231 to 236, and through bending, each of the six sides 231 to 236 can have at least a portion of a straight line.

Furthermore, each of the six sides 231 to 236 can form a vertex V with an adjacent side. Accordingly, each of the plurality of coils 230a to 230r can have six vertices V. The vertices V may be pointed, as illustrated in FIG. 6. However, depending on the embodiment, instead of a vertex V, each side may be connected to an adjacent side in a rounded shape.

The coil may have at least one turn N. Additionally, the turn N can be formed by at least one unit coil.

Referring to (a) of FIG. 6, each of the plurality of coils 230a to 230r has a plurality of turns N, and each of the plurality of turns N can be formed into a plurality of unit coils 240. In FIG. 6, each of the plurality of coils 230a to 230r is illustrated as having 8 turns N1, N2, N3, N4, N5, N6, N7, and N8, but this is merely an example. That is, the number of turns of each of the plurality of coils 230a to 230n can be changed.

According to the first embodiment, each of the plurality of turns N1, N2, N3, N4, N5, N6, N7, and N8 constituting the coil can be formed into a single unit coil. That is, each of the plurality of turns constituting the coil may include one unit coil. In this case, the thickness of the unit coil may be thicker than the thickness of the unit coil according to the second embodiment described below.

According to the second embodiment, as illustrated in the drawings, each of the plurality of turns N1, N2, N3, N4, N5, N6, N7, and N8 constituting the coil may be formed as the plurality of strands of unit coils. That is, each of the plurality of turns constituting the coil may include a plurality of unit coils.

Meanwhile, the plurality of unit coils may be formed on only one of the two surfaces of the substrate 210, or may be formed on both surfaces. That is, the plurality of unit coils may be formed only on the upper surface of the substrate 210, only on the lower surface of the substrate 210, or on both the upper and lower surfaces of the substrate 210.

Hereinafter, the unit coil formed on the upper surface of the substrate 210 may refer to a unit coil formed on the upper surface of the substrate 210 at a point connected to the first terminal T1. Furthermore, the unit coil printed on the upper surface of the substrate 210 may refer to a unit coil printed on the upper surface of the substrate 210 at a point connected to the first terminal T1.

Meanwhile, the unit coil formed on the lower surface of the substrate 210 may refer to a unit coil formed on the lower surface of the substrate 210 at a point connected to the first terminal T1. Furthermore, the unit coil printed on the lower surface of the substrate 210 may refer to a unit coil printed on the lower surface of the substrate 210 at a point connected to the first terminal T1.

The drawings attached to this specification illustrate a case where the plurality of unit coils are formed on both the upper and lower surfaces of the substrate 210. That is, the plurality of unit coils can be printed on both the upper and lower surfaces of the substrate 210.

(a) of FIG. 6 illustrates unit coils printed on the upper surface of the substrate 210, and (b) of FIG. 6 illustrates unit coils printed on the lower surface of the substrate 210. (a) of FIG. 7 illustrates unit coils printed on the upper surface of the substrate 210 in solid lines, and unit coils printed on the lower surface of the substrate 210 in dotted lines.

When a plurality of unit coils are printed on both the upper and lower surfaces of the substrate 210, the unit coils printed on the upper surface and the unit coils printed on the lower surface can be arranged alternately. That is, the unit coils on the upper surface can be arranged adjacent to the unit coils on the lower surface, and the unit coils on the lower surface can be arranged adjacent to the unit coils on the upper surface.

In this case, there is an advantage of increasing the density of the unit coils. Specifically, each unit coil must be spaced apart from adjacent unit coils for insulation, and the closer the unit coils are arranged, the higher the coil density. However, if the unit coils are printed on only one side of the substrate 210, there is a limitation in that it is difficult to narrow the distance between adjacent unit coils. As illustrated in (a) of FIG. 7, if the unit coils are printed on both sides of the substrate 210 and the unit coils on the upper surface and the unit coils on the lower surface are arranged alternately, there is an advantage in that the distance between the unit coils can be minimized and the density of the unit coils can be maximized.

Referring to the example of (a) of FIG. 7, it can be confirmed that one turn is composed of a total of 11 unit coils. The plurality of unit coils 240 may include the first to eleventh unit coils 201, 202, 203, 204, 205, 206, 207, 208, 209, 210, and 211. It can be confirmed that among the plurality of unit coils, the number of unit coils printed on the upper surface of the substrate 210 is six, and the number of unit coils 240 printed on the lower surface of the substrate 210 is five. Specifically, the unit coils printed on the upper surface of the substrate 210 are the first, third, fifth, seventh, ninth, and eleventh unit coils 201, 203, 205, 207, 209, 211. Additionally, the unit coils printed on the lower surface of the substrate 210 are the second, fourth, sixth, eighth, and tenth unit coils 202, 204, 206, 208, and 210.

Each of the plurality of unit coils may be arranged sequentially from the closest position to the furthest position from the center of the coil. Furthermore, each of the plurality of unit coils may be alternately arranged on the upper and lower surfaces of the substrate 210. That is, each of the plurality of unit coils may be alternately printed on the upper and lower surfaces of the substrate 210.

Meanwhile, each of the plurality of unit coils may be divided into a plurality of segments. Specifically, each of the plurality of unit coils may be divided into a segment printed on the upper surface of the substrate 210 and a segment printed on the lower surface of the substrate 210.

The segments may have a shape that is bent at the vertex V such that the coil has a hexagonal shape.

The vertices of the segments printed on the upper surface of the substrate 210 may be formed to be inclined at a predetermined angle in the clockwise direction compared to the vertices of the segments printed on the lower surface of the substrate 210.

The vertices of the segments printed on the upper surface of the substrate 210 may be, in counterclockwise order from the first terminal T1, the 1-1st vertex V1-1, the 1-2nd vertex V1-2, the 1-3rd vertex V1-3, the 1-4th vertex V1-4, the 1-5th vertex V1-5, and the 1-6th vertex V1-6.

The vertices of the segments printed on the lower surface of the substrate 210 may be, in counterclockwise order from the first terminal T1, the 2-1st vertex V2-1, the 2-2nd vertex V2-2, the 2-3rd vertex V2-3, the 2-4th vertex V2-4, the 2-5th vertex V2-5, and the 2-6th vertex V2-6.

The segments printed on the upper surface of the substrate 210 may have a shape that is bent outward from the turn N between the vertices.

The segments printed on the lower surface of the substrate 210 may have a shape that is bent inward from the turn N between the vertices.

The segments of the unit coil may be alternately printed on the upper and lower surfaces of the substrate 210.

The segment printed on the upper surface of the substrate 210 and the segment printed on the lower surface of the substrate 210 may be connected via a via 250.

The via 250 may be formed at one end of the segment.

The segment in which the via 250 is formed may be a segment in which at least a portion forms the outermost corner of a turn N. The via 250 may be formed at one end of the segment that forms the outermost corner of a turn N.

Alternatively, the segment in which the via 250 is formed may be a segment in which at least a portion forms the innermost corner of a turn N. The via 250 may be formed at one end of the segment that forms the innermost corner of a turn N.

The via 250 may be formed at both ends of the segment.

A via 250 may be formed at both ends of a segment, at least a portion of which forms the outermost corner of a turn N, and another portion of which forms the innermost corner of the turn N.

First, an embodiment in which a via 250 is formed at one end of a segment, and the segment in which the via 250 is formed is a segment at least a portion of which forms the outermost corner of a turn N, will be described. The first unit coil 201 may be divided into a first segment 201-1, a second segment 201-2, and a third segment 201-3.

The first segment 201-1 may be a segment connected to the first terminal T1. The first segment 201-1 may be a segment printed on the upper surface of the substrate 210.

The first segment 201-1 may be a segment positioned at the innermost side of the turn N at a point connected to the first terminal T1.

The first segment 201-1 may have a shape that is bent outward from the turn N between the first-first vertex V1-1 and the first-second vertex V1-2.

Next, the first segment 201-1 may have a shape that is bent outward from the turn N between the first-second vertex V1-2 and the first-third vertex V1-3.

Next, the first segment 201-1 may have a shape that is bent outward from the turn N between the first-third vertex V1-3 and the first-fourth vertex V1-4.

Accordingly, the first segment 201-1 can form the outermost angle of the turn N between the first-third vertex V1-3 and the first-fourth vertex V1-4.

A first via 251 can be formed at the point where the first segment 201-1 forms the outermost angle of the turn N.

The first via 251 can be a via for connecting the first segment 201-1 and the second segment 201-2.

The second segment 201-2 can be a segment printed on the lower surface of the substrate 210.

The second segment 201-2 can also form the outermost angle of the turn N. Specifically, the second segment 201-2 may form the outermost corner of the turn N at a point where it is connected to the first segment 201-1 via the first via 251.

That is, the first via 251 may be formed at the point where the second segment 202-1 forms the outermost corner of the turn N.

In this way, when at least a portion of the segment forms the outermost corner of the turn N, a via 250 may be formed at one end of the segment. The end at which the via 250 is formed may be the one of both ends of the segment that forms the outermost corner of the turn N.

Next, an embodiment will be described in which the via 250 is formed at one end of the segment, and the segment at which the via 250 is formed is a segment at least a portion of which forms the innermost corner of the turn N.

The second segment 201-2 of the first unit coil may be a segment positioned at the outermost corner of the turn N at a point connected to the first segment 201-1 via the first via 251.

The second segment 202-2 may have a shape that is bent inwardly of the turn N between the 2-3rd vertex V2-3 and the 2-4th vertex V2-4.

Next, the second segment 201-2 may have a shape that is bent inwardly of the turn N between the 2-4th vertex V2-4 and the 2-5th vertex V2-5.

Next, the second segment 201-2 may be bent at the 2-6th vertex V2-6 such that the coils 230a to 230n have a hexagonal shape.

The vertices of the segments printed on the lower surface of the substrate 210 may be formed to be inclined at a predetermined angle clockwise relative to the vertices of the segments printed on the upper surface of the substrate 210.

Accordingly, the second segment 201 may have a shape that bends inward of the turn N earlier than the third segment 203-3 of the third unit coil, which bends at the 1-6th vertex V1-6.

Accordingly, the second segment 201-2 may form the innermost angle of the turn N between the 2-6th vertex V2-6 and the 2-1st vertex V2-1.

A second via 252 may be formed at the point where the second segment 201-2 forms the innermost angle of the turn N.

The second via 252 may be a via for connecting the second segment 201-2 and the third segment 201-3.

The third segment 201-3 may be a segment printed on the upper surface of the substrate 210.

The third segment 201-3 may also form the innermost angle of the turn N. Specifically, the third segment 201-3 may form the innermost angle of the turn N at a point where it is connected to the second segment 201-2 via the second via 252.

That is, the second via 252 may be formed at the end where the third segment 201-3 forms the innermost angle of the turn N. In this way, when at least a portion of the segment forms the innermost angle of the turn N, a via 250 may be formed at one end of the segment. The end where the via 250 is formed may be the only one of the two ends of the segment that forms the innermost angle of the turn N.

Next, an embodiment will be described in which a via 250 is formed at both ends of a segment, and the segment in which the via 250 is formed is a segment in which a portion forms the outermost angle of a turn N and another portion forms the innermost angle of the turn N.

As described above, the second segment 201-2 of the first unit coil may have a portion form the outermost angle of a turn N and another portion form the innermost angle of the turn N.

Specifically, the second segment 201-2 may form the outermost angle of a turn N between the 2-3 vertex V2-3 and the 2-4 vertex V2-5. Additionally, the second segment 201-2 may form the innermost angle of a turn between the 2-6th vertex V2-6 and the 2-1st vertex V2-1.

A first via 251 may be formed at one end where the second segment 201-2 forms the outermost angle of the turn N. Additionally, a second via 252 may be formed at the other end where the second segment 201-2 forms the innermost angle of the turn N.

In this way, when at least a portion of a segment forms the outermost angle of the turn N and another portion forms the innermost angle of the turn N, a via 250 may be formed at both ends of the segment.

In this way, each turn may be formed of a plurality of unit coils 240 including a plurality of segments.

The unit coils may be alternately arranged on the upper and lower surfaces of the substrate 210.

Additionally, some of the plurality of segments included in the unit coil may be segments formed on the upper surface of the substrate 210. The remaining portion of the plurality of segments included in the unit coil may be segments formed on the lower surface of the substrate 210. The segments formed on the upper surface of the substrate 210 and the segments printed on the lower surface may be alternately arranged.

Furthermore, the segments formed on the upper surface of the substrate 210 may have a shape that bends outward from the turns N between each vertex V. The segments formed on the lower surface of the substrate 210 may have a shape that bends inward from the turns N between each vertex V.

Accordingly, the segments may be formed to intersect with segments of other unit coils formed on other surfaces of the substrate 210.

Accordingly, the unit coil 240 may have a twisted structure. That is, the coil may have a Litz wire structure.

That is, according to an embodiment of the present disclosure, a coil printed on a substrate 210 can provide an induction heating member having a Litz wire structure. In this way, when the plurality of unit coils 240 are printed on the substrate 210 to form each turn of the coil, there is an advantage in minimizing energy loss occurring in the conductor due to the skin effect.

Conventionally, small coils were manufactured by winding them into a Litz wire structure. However, according to the present disclosure, an induction heating member can be provided in which the coil is printed in a Litz wire pattern. Thus, the process of manufacturing a coil by printing it on a substrate is simpler than the process of manufacturing it by winding it, and thus, the variation between coils is reduced. Additionally, when the plurality of small Litz wire coils are to be placed to avoid specifying a heating zone, the process of printing the coils onto the substrate allows for one-time manufacturing, offering the advantage of excellent assembly.

As illustrated in (a) of FIG. 7, the coils formed on the substrate 210 have a twisted structure and can be interconnected via vias 250 to support this twisted structure.

Meanwhile, the vias are preferably selected at appropriate locations to ensure an insulating distance between the coils formed on the substrate 210.

To illustrate the selection of via locations to secure an insulating distance, (b) of FIG. 7 is an enlarged view of the portion circled in (a) of FIG. 7.

Referring to (b) of FIG. 7, the vias can be positioned at points where the pattern extends laterally, bending from the linear direction in which the pattern progresses.

Meanwhile, the pattern's bending angle and position can be selected such that the area where the upper and lower patterns intersect (e.g., the hatched portion in (b) of FIG. 7) is horizontal while maintaining a minimum insulation distance. A via hole can be formed at the selected position.

In the above case, if the pattern's bending angle is greater than a predetermined critical angle, the distance between coil strands may increase to secure the insulation distance between via holes. In this case, the coil integration may decrease.

Furthermore, if the pattern's bending angle is greater than a predetermined critical angle, the distance between turns may increase, resulting in an increase in product size when the same integration is required.

In other words, the pattern's bending angle is preferably determined by considering the turn-to-turn distance 710 and the strand-to-strand distance (720). This also allows the location of vias to secure an insulating distance.

Next, a structure in which induction heating members are laminated in the plurality of layers is described. The induction heating members may also be implemented in a structure in which the plurality of layers are laminated. That is, the induction heating device according to an embodiment of the present disclosure may be formed in a structure in which the plurality of induction heating members are laminated as described above.

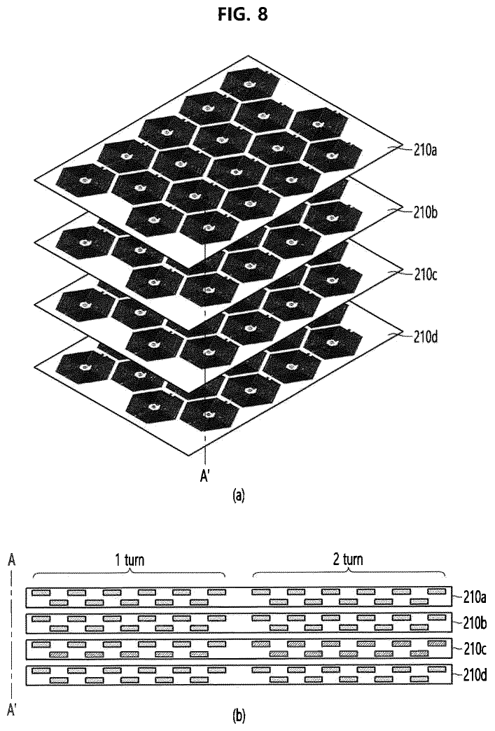

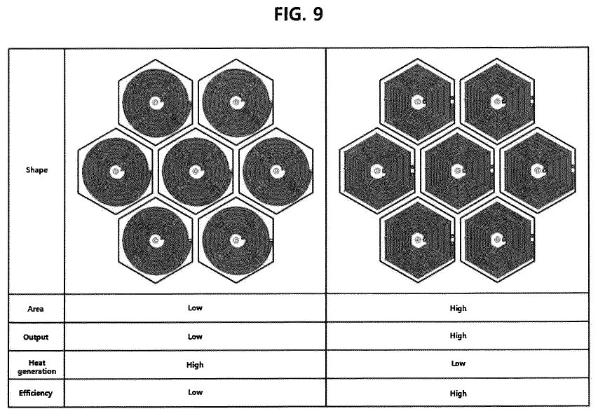

FIG. 8 is a drawing illustrating an induction heating device according to an embodiment of the present disclosure.

Referring to (a) of FIG. 8, the induction heating device may be formed by vertically stacking four induction heating members. The number of induction heating members constituting the induction heating device is merely exemplary, and the number of induction heating members may vary.

The plurality of induction heating members may be connected in series. When induction heating members are connected in series in this manner, the output of the cooktop 10 can be increased.

Furthermore, the cooktop according to an embodiment of the present disclosure may include at least one induction heating member described above. That is, the cooktop according to an embodiment of the present disclosure may include at least one induction heating member instead of the working coil 150 illustrated in FIG. 2. Alternatively, a cooktop according to an embodiment of the present disclosure may include at least one induction heating device instead of the working coil 150 illustrated in FIG. 2.

(a) of FIG. 8 illustrates four vertically stacked induction heating members 201a-210o, and (b) of FIG. 8 illustrates a cross-sectional view taken along line A-A′ of (a) of FIG. 8.

As in the present disclosure, when the plurality of coils 230a to 230r are printed in a hexagonal shape rather than a circle, the the plurality of coils 230a to 230r are advantageously arranged more closely together.

FIG. 9 illustrates characteristics of the plurality of coils printed in circular and hexagonal shapes, respectively.

Referring to FIG. 9, it can be confirmed that dead space, which is ineffective when the coils are printed in a hexagonal shape, is minimized compared to when the coils are printed in a circular shape.

That is, the total area of the coils on the substrate 210 is larger when the coils are printed hexagonally than when they are printed circularly.

Furthermore, at the same current, the larger the total area of the coil, the higher the output. Therefore, the output of the cooktop 10 is higher when the coils are printed hexagonally than when they are printed circularly.

Furthermore, for the same output, the lower the current, the smaller the loss, resulting in lower heat generation. Therefore, the heat generation from the heating member is lower when the coils are printed hexagonally than when they are printed circularly.

Therefore, the efficiency of the cooktop 10 is higher when the coils are printed hexagonally than when they are printed circularly.

That is, compared to the circular form, the hexagonal form has the advantage of lower current relative to output, reducing heat generation and increasing maximum output.

In addition, as described above, when the coil is printed in a hexagon, the total area of the coil increases, thereby minimizing the problem of areas not reaching the magnetic field and thus not being heated. That is, according to the present disclosure, a cooktop 10 is provided in which a plurality of relatively small coils 230a to 230r are closely arranged, and in this case, since no separate heating zone is designated, the degree of freedom in the positioning of the cooking vessel 1 is secured, while the area of the non-heating area is advantageously minimized.

According to one embodiment, a device such as a temperature sensor may be further inserted into the substrate 210.

The above description is merely an illustrative description of the technical idea of the present disclosure, and those skilled in the art to which the present disclosure pertains will appreciate that various modifications and variations may be made without departing from the essential characteristics of the present disclosure.

Therefore, the embodiments disclosed in this disclosure are intended to illustrate, rather than limit, the technical concepts of this disclosure, and the scope of the technical concepts of this disclosure is not limited by these embodiments.

The scope of protection of this disclosure should be interpreted by the following claims, and all technical concepts within the scope equivalent thereto should be construed as being included within the scope of the present disclosure.

### INDUSTRIAL APPLICABILITY

The present disclosure relates to a cooking appliance including an induction heating member, such as a PCB pattern coil, and has industrial applicability.

1. An induction heating member comprising:
a substrate; and
a heating element printed on the substrate,
wherein the heating element includes at least one coil printed in a hexagonal shape.

2. The induction heating member of claim 1, wherein the coil has at least one turn, and the turn is formed of a plurality of unit coils.

3. The induction heating member of claim 2, wherein the plurality of unit coils is alternately arranged on an upper surface and a lower surface of the substrate.

4. The induction heating member of claim 2, wherein each of the plurality of unit coils is divided into a segment printed on the upper surface of the substrate and a segment printed on the lower surface of the substrate.

5. The induction heating member of claim 4, wherein the segment printed on the upper surface and the segment printed on the lower surface are connected through a via.

6. The induction heating member of claim 5, wherein the via is formed at one end of the segment, and the segment is a segment that forms at least a portion of an outermost turn.

7. The induction heating member of claim 5, wherein the via is formed at one end of the segment, and the segment is a segment that forms at least a portion of an innermost turn.

8. The induction heating member of claim 5, wherein the via is formed at both ends of the segment, and the segment forms a portion of an outermost turn and a remaining portion of an innermost turn.

9. The induction heating member of claim 1, wherein, a first coil among the plurality of coils has a plurality of adjacent coils, and the first coil is printed such that a distance to each of the plurality of adjacent coils is the same.

10. An induction heating device, wherein the induction heating member according to claim 1 is formed in a structure in which a plurality of the induction heating members are vertically stacked.

11. A cooktop comprising at least one induction heating member according to claim 1.
